(19) United States
(12) Patent Application Publication
(10) Pub. No.: US 2018/0334071 A1
(43) Pub. Date: Nov. 22, 2018

(54) TRUCK BED LOADING SYSTEM

(71) Applicant: FORD GLOBAL TECHNOLOGIES, LLC, Dearborn, MI (US)

(72) Inventors: Dragan B. STOJKOVIC, Taylor, MI (US); Joshua Robert HEMPHILL, White Lake, MI (US); Jack MARCHLEWSKI, Saline, MI (US); Jeffrey GRAY, Dearborn, MI (US); Robert REINERS, Grosse Ile, MI (US)

(21) Appl. No.: 15/596,708

(22) Filed: May 16, 2017

(51) Int. Cl. B60P 1/43

(52) U.S. Cl. CPC B60P 1/435; B62D 33/03

(57) ABSTRACT

A vehicle includes a bed, first container, second container, first elongate tubular platform, second elongate tubular platform, and extendable ramps. The bed has first and second side panels that extend upward from a floor panel. The first and second containers are secured to the floor panel adjacent to the first and second side panels, respectively. The first and second elongate tubular platforms are rotatably secured to tops of the first and second containers, respectively, such that flat bottoms of the platforms face upwards when rotated inboard relative to bed. One of the extendable ramps are disposed within each platform

### TECHNICAL FIELD

The present disclosure relates to vehicles, such as trucks, that include cargo beds and tailgates that provide access to the cargo beds.

### BACKGROUND

Pickup trucks include cargo beds that are configured to received and store cargo being transported.

### SUMMARY

A vehicle includes a bed, first container, second container, first elongate tubular platform, second elongate tubular platform, and extendable ramps. The bed has first and second side panels that extend upward from a floor panel. The first and second containers are secured to the floor panel adjacent to the first and second side panels, respectively. The first and second elongate tubular platforms are rotatably secured to tops of the first and second containers, respectively, such that flat bottoms of the platforms face upwards when rotated inboard relative to bed. One of the extendable ramps are disposed within each platform.

A truck bed includes a side panel, floor, headboard, tailgate, storage container, elongate tubular platform, and ramp. The side panel defines a wheel well and extends upward from the floor panel between the headboard and the tailgate. The storage container is secured to the floor panel and over the wheel well. The elongate tubular platform is rotatably secured to the container and is configured to rotate inboard about a first axis that extends from the headboard to the tailgate. The ramp is disposed within the platform.

A truck bed loading system includes a first podium, second podium, first elongate loading platform, second elongate loading platform, and extendable ramps. The first and second podiums are secured to a floor of a bed adjacent to the first and second side panels of the bed, respectively. The first and second elongate loading platforms each define internal cavities and are rotatably secured to tops of the first and second podiums, respectively. The first and second elongate loading platforms are configured to rotate inboard about axes that extend from a headboard to a tailgate of the bed. One of the extendable ramps is disposed within each cavity.

### BRIEF DESCRIPTION OF THE DRAWINGS

FIG. 1 is a perspective view of a vehicle having a cargo or truck bed;

FIG. 2 is a perspective view of the truck bed, including a loading system, shown with a tailgate of the truck bed in a down position;

FIG. 3 is a top view of the truck bed and the loading system;

FIG. 4 is partial side view of the truck bed and the loading system;

FIG. 5 is a rear view of the loading system;

FIG. 6 is a perspective view of a horseshoe bracket;

FIG. 7 is a top view the truck bed 14 having an alternative embodiment of the loading system; and

FIG. 8 is a rear view of a portion of the alternative embodiment of the loading system.

### DETAILED DESCRIPTION

Embodiments of the present disclosure are described herein. It is to be understood, however, that the disclosed embodiments are merely examples and other embodiments may take various and alternative forms. The figures are not necessarily to scale; some features could be exaggerated or minimized to show details of particular components. Therefore, specific structural and functional details disclosed herein are not to be interpreted as limiting, but merely as a representative basis for teaching one skilled in the art to variously employ the embodiments. As those of ordinary skill in the art will understand, various features illustrated and described with reference to any one of the figures may be combined with features illustrated in one or more other figures to produce embodiments that are not explicitly illustrated or described. The combinations of features illustrated provide representative embodiments for typical applications. Various combinations and modifications of the features consistent with the teachings of this disclosure, however, could be desired for particular applications or implementations.

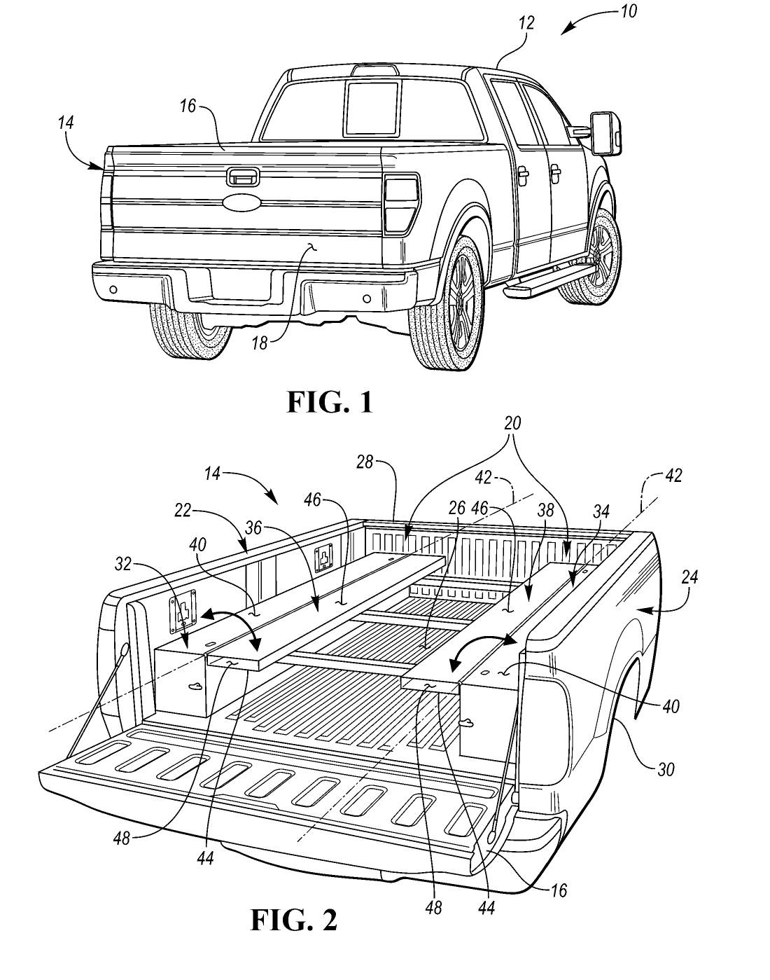

Referring to FIG. 1, a vehicle 10 is illustrated. The illustrated vehicle 10 may be a truck. The vehicle 10 may include a body 12 (that includes a cabin space) and a cargo bed (or truck bed) 14. The body 12 and the cargo bed 14 may each be secured to a frame. A tailgate 16 that provides access to the cargo bed 14 may be rotatably secured to the cargo bed 14. The tailgate is shown to be in an up and closed position such that an external panel (or exterior surface) 18 of the tailgate 16 is visible from the rear of the vehicle 10. The body 12 and cargo bed 14 may include various components of the vehicle's body-in-white structure. The body-in-white structure may include roof rails, pillars (such as A-pillars, B-pillars, C-pillars, D-pillar, etc.), side rails, front rails, rear rails, rocker panels, strut or shock towers, roof cross members, floor cross members, floor panels, roof panels, firewalls, radiator core supports, powertrain component supports (e.g., engine or transmission supports), or any other component of the vehicle body-in-white structure or the frame known in the art. The body components may be connected to each other by a welding process or by fasteners, such as rivets, screws, bolts, or any other type of faster known to a person of ordinary skill in the art.

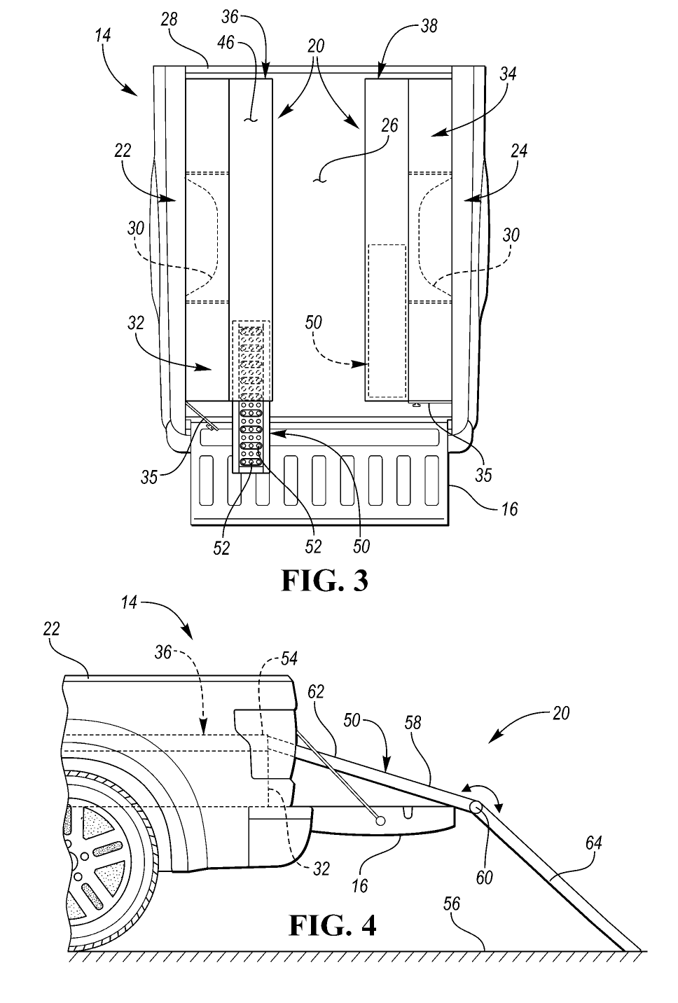

Referring to FIGS. 2 and 3, a perspective view and a top view of the truck bed 14, including a loading system 20 for the truck bed 14, with the tailgate 16 in a down position are respectively illustrated. The truck bed 14 has a first side panel 22, a second side panel 24, and a floor (or floor panel) 26. The first side panel 22 and the second side panel 24 each extend upward from the floor panel 26. The first side panel 22 and the second side panel 24 may be secured to opposing sides of the floor panel 26. The first side panel 22 and the second side panel 24 may extend from a front to a back of the floor panel 26 and between a headboard 28 of truck bed 14 and the tailgate 16. Each of the first side panel 22 and the second side panel 24 may also define a wheel well 30.

The loading system 20 of the truck bed 14 may include a first podium 32 and a second podium 34. The first podium 32 and the second podium 34 may be secured to the floor panel 26 adjacent to the first side panel 22 and the second side panel 24, respectively. The first podium 32 and the second podium 34 also each be secured to the first side panel 22 and second side panel 24, respectively, and/or disposed over the wheel wells 30 of the first side panel 22 and second side panel 24, respectively. The first podium 32 and the second podium 34 may also define internal cavities that may be used for storage purposes. Therefore, the first podium 32 and the second podium 34 may alternatively be referred to as the first and second storage containers, respectively. The internal cavities defined by the first podium 32 and the second podium 34 may be partitioned to create forward and rearward storage spaces that are separated from the wheel wells 30. The first podium 32 and the second podium 34 may also include hatches or doors 35 that provide access to the storage spaces. The doors 35 may be located on the tops or the sides of the first podium 32 and the second podium 34.

The loading system 20 may also include a first elongate tubular platform 36 and a second elongate tubular platform 38. The first platform 36 and the second platform 38 may be rotatably secured to tops 40 of the first podium 32 and the second podium 34, respectively. The first platform 36 and the second platform 38 may each be configured to rotate inboard relative to the truck bed 14 about axes 42 that extend from the headboard 28 to a tailgate 16. The first platform 36 and the second platform 38 may also extend from the headboard 28 to a tailgate 16. The first platform 36 and the second platform 38 may rest flat upon the tops 40 of the first podium 32 and the second podium 34, respectively, when in a non-rotated position such that flat tops 44 of the first platform 36 and the second platform 38 face upwards. Flat bottoms 46 of the first platform 36 and the second platform 38 may face upwards when rotated inboard relative to truck bed 14.

The first elongate tubular platform 36 and second elongate tubular platform 38 may each also define internal cavities 48. Extendable ramps 50 may be disposed within each cavity 48 of the first platform 36 and the second platform 38. The extendable ramps 50 may be disposed within each cavity 48 and may be configured to extend out of the cavities 48 toward the tailgate 16. The ramps 50 are configured to transition to extended positions when the first platform 36 and the second platform 38 are rotated inboard relative to the truck bed 14 and the flat bottoms 46 of the first platform 36 and the second platform 38 are facing upwards. The ramps 50 may define perforations 52. Rough edges may be formed about each perforation 52 to increase the traction of the ramps 50. Hooks or clasps secured to the ends of each ramp 50 may engage notches or slots defined in the ends of the first platform 36 and the second platform 38 to secure the ends of the ramps 50 to the ends of the first platform 36 and the second platform 38 when the ramps 50 are fully extended. It should be understood, however, that other mechanisms may be used to the secure the ends of each ramp 50 to the ends of the first platform 36 and the second platform 38 when the ramps 50 are fully extended.

A bearing system (e.g., ball or roller bearing) may be disposed within each cavity 48 to decrease the friction between the ramps 50 and the internal surfaces of the first platform 36 and the second platform 38. The bearing system may also act to guide the ramps 50 when sliding into or out of the cavities 48. A locking system may also be utilized to secure the ramps 50 with the cavities 48 when the ramps 50 are completely retracted into the cavities. The locking system may include a spring-loaded latch. Additionally, the locking system may include tumbler that requires a key to unlock the latch.

Referring to FIG. 4, a partial side view of the truck bed 14 and loading system 20 is illustrated. The ramps 50 are shown in extended positions. When in the extended positions, the ramps 50 extend from ends 54 of the first platform 36 and second platform 38, over the tailgate 16 when in a down position, and to the ground 56. The ramps 50 may function as a pathway for cargo being loaded onto of the first platform 36, second platform 38, first podium 32, and/or the second podium 34. For example, an off road vehicle, such as a four-wheeler, may be driven up the ramps and onto the first platform 36 and second platform 38. A mid-portion 58 of each ramp 50 is disposed on top of the tailgate 16 when the ramps 50 are in the extended position and the tailgate 16 is in the down position. Each ramp 50 may include a pivot joint 60 that is disposed outboard of the tailgate 16 when the ramps 50 are in the extended position and the tailgate 16 is in the down position. The pivot joints 60 may partition the ramps into two sections, an inboard section 62 and an outboard section 64, that are configured to rotate relative to each other about the pivot joint 60. The pivot joint 60 allows the ramps 50 to extend from the first platform 36 and the second platform 38 to the ground 56 over a shorter distance by increasing the slope of the ramp 50 once it has cleared the tailgate.

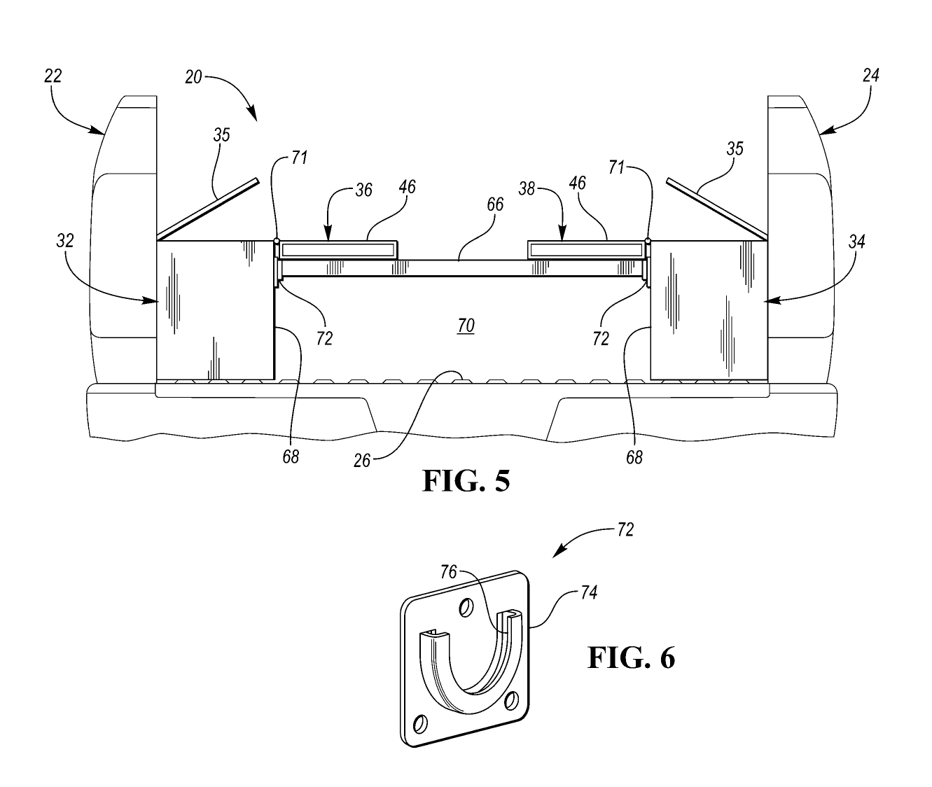

Referring to FIG. 5, a rear view of the loading system 20 is illustrated. The loading system 20 includes at least one support bar 66 that is secured to internal sides 68 of each of the first podium 32 and the second podium 34 such the at least one support bar 66 spans a space 70 (which also may be used for storage) defined between the first podium 32 and the second podium 34. The first platform 36 and the second platform 38 are disposed on top of the at least one support bar 66 when rotated inboard about hinges 71 (that extend in the direction of the axes 42 shown in FIG. 2) such that the flat bottoms 46 of the first platform 36 and the second platform 38 are facing upwards. The at least one support bar 66 functions to secure the rotated inboard positions of the first platform 36 and second platform 38, and may also function to provide structural support to the first platform 36, second platform 38, and any cargo that may be resting upon the first platform 36 and/or second platform 38.

Referring to FIG. 6, a perspective view of a horseshoe bracket 72 is illustrated. The horseshoe bracket 72 may include backing plate 74 and a cradle portion 76 that protrudes from the backing plate 74. The at least one support bar 66 may be secured to the internal sides 68 of the first podium 32 and the second podium 34 by engaging horseshoe brackets 72 that are in turn secured to the internal sides 68 of the first podium 32 and the second podium 34. The horseshoe brackets may be secured to the internal sides 68 of the first podium 32 and the second podium 34 by welds, an adhesive, fasteners (e.g., bolt, screws, rivets), or by any other practical means. Ends of the at least one support bar 66 may be configured to slide into and rest upon the cradle portions 76 of the horseshoe brackets 72.

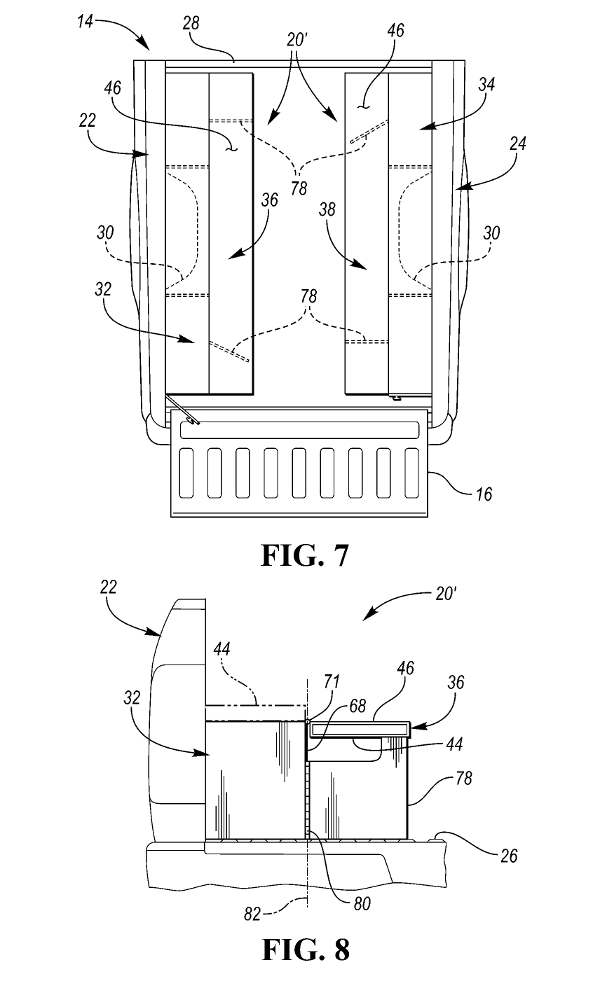

Referring to FIGS. 7 and 8, a top view of the truck bed 14 having an alternative embodiment of the loading system 20′ and a rear view of a portion of the alternative embodiment of the loading system 20′ are respectively illustrated. Unless otherwise stated herein, the alternative embodiment of the loading system 20′ will have all of the attributes of loading system 20. The alternative embodiment of the loading system 20′ includes support plates 78 that are rotatably secured to the internal sides 68 of the first podium 32 and the second podium 34 by hinges 80 that rotate about vertical axes 82. The support plates 78 extend from the floor panel 26 of the truck bed 14 to the first platform 36 and the second platform 38. The first platform 36 and the second platform 38 are disposed on top of the support plates when the support plates 78 have been rotated outward from the internal sides 68 of the first podium 32 and the second podium 34, and when the first platform 36 and the second platform 38 have been rotated inboard relative to the truck bed 14 such that flat tops 44 of the first platform 36 and the second platform 38 face upwards. The support plates 78 function to secure the rotated inboard positions of the first platform 36 and second platform 38, and may also function to provide structural support to the first platform 36, second platform 38, and any cargo that may be resting upon the first platform 36 and/or second platform 38.

The words used in the specification are words of description rather than limitation, and it is understood that various changes may be made without departing from the spirit and scope of the disclosure. As previously described, the features of various embodiments may be combined to form further embodiments that may not be explicitly described or illustrated. While various embodiments could have been described as providing advantages or being preferred over other embodiments or prior art implementations with respect to one or more desired characteristics, those of ordinary skill in the art recognize that one or more features or characteristics may be compromised to achieve desired overall system attributes, which depend on the specific application and implementation. As such, embodiments described as less desirable than other embodiments or prior art implementations with respect to one or more characteristics are not outside the scope of the disclosure and may be desirable for particular applications.

What is claimed is:

1. A vehicle comprising:
a bed having first and second side panels extending upward from a floor panel;
first and second containers secured to the floor panel adjacent to the first and second side panels, respectively;
first and second elongate tubular platforms rotatably secured to tops of the first and second containers, respectively, such that flat bottoms of the platforms face upwards when rotated inboard relative to bed; and
extendable ramps disposed within each platform.

2. The vehicle of claim 1 further comprising at least one support bar secured to internal sides of each container such the at least one support bar spans a space defined between the containers, wherein the platforms are disposed on top of the at least one support bar when rotated inboard relative to the bed.

3. The vehicle of claim 2, wherein the at least one support bar is secured to the internal sides of each container by engaging horseshoe brackets that are secured to the internal sides of each container.

4. The vehicle of claim 1 further comprising support plates that are rotatably secured to internal sides of each container about vertical axes, the support plates extending from the floor panel to the platforms, wherein the platforms are disposed on top of the support plates when the support plates are rotated outward from the internal sides and the platforms are rotated inboard relative to the bed.

5. The vehicle of claim 1, wherein the bed further comprises a headboard and a tailgate, and wherein the platforms extend from the headboard toward the tailgate.

6. The vehicle of claim 5, wherein the ramps are configured to transition to extended positions that extend from ends of the platforms, over the tailgate when in a down position, and to the ground.

7. The vehicle of claim 6, wherein mid-portions of the ramps are disposed on top of the tailgate when the ramps are in the extended position and the tailgate is in the down position.

8. The vehicle of claim 7, wherein the ramps include a pivot joint that is disposed outboard of the tailgate when the ramps are in the extended position and the tailgate is in the down position.

9. A truck bed comprising:
a side panel defining a wheel well and extending upward from a floor panel between a headboard and a tailgate;
a storage container secured to the floor panel and over the wheel well;
an elongate tubular platform rotatably secured the container and configured to rotate inboard about a first axis that extends from the headboard to the tailgate; and
a ramp disposed within the platform.

10. The truck bed of claim 9 further comprising at least one support bar secured to an internal side of the container, wherein the platform is disposed on top of the at least one support bar when rotated inboard.

11. The truck bed of claim 10, wherein the at least one support bar is secured to the internal side of the container by engaging a horseshoe bracket that is secured to the internal side of the container.

12. The truck bed of claim 9 further comprising a support plate that is rotatably secured to an internal side of the container about a vertical axis, the support plate extending from the floor panel to the platform, wherein the platform is disposed on top of the support plate when the support plate is rotated outward from the internal side and the platform is rotated inboard.

13. The truck bed of claim 12, wherein the ramp is configured to transition to an extended position that extends from an end of the platform, over the tailgate when in a down position, and to the ground.

14. The truck bed of claim 13, wherein a mid-portion of the ramp is disposed on top of the tailgate when the ramp is in the extended position and the tailgate is in the down position.

15. The truck bed of claim 14, wherein the ramp includes a pivot joint that is disposed outboard of the tailgate when the ramp is in the extended position and the tailgate is in the down position.

16. A truck bed loading system comprising:
first and second podiums secured to a floor of a bed adjacent to first and second side panels of the bed, respectively;
first and second elongate loading platforms, each defining internal cavities, rotatably secured to tops of the first and second podiums, respectively, and configured to rotate inboard about axes that extend from a headboard to a tailgate of the bed; and
extendable ramps disposed within each cavity.

17. The truck bed loading system of claim 16 further comprising at least one support bar secured to internal sides of each podium such that the at least one support bar spans a space defined between the podiums, wherein the platforms are disposed on top of the at least one support bar when rotated inboard relative to the bed.

18. The truck bed loading system of claim 17, wherein the at least one support bar is secured to the internal sides of each podium by engaging horseshoe brackets that are secured to the internal sides of each podium.

19. The truck bed loading system of claim 16 further comprising support plates that are rotatably secured to internal sides of each podium about vertical axes, the support plates extending from the floor to the platforms, wherein the platforms are disposed on top of the support plates when the support plates are rotated outward from the internal sides and the platforms are rotated inboard.

20. The truck bed loading system of claim 16, wherein the ramps are configured to transition to extended positions that extend from ends of the platforms, over the tailgate when in a down position, and to the ground.
